(19) United States
(12) Patent Application Publication
(10) Pub. No.: US 2010/0059352 A1
(43) Pub. Date: Mar. 11, 2010

(54) Weld Breaking Contactor

(75) Inventors: Eric J. Webb, Vancouver, WA (US); Bryan M. Averill, Portland, OR (US)

Correspondence Address: HARNESS, DICKEY & PIERCE, P.L.C., P.O. BOX 828, BLOOMFIELD HILLS, MI, 48303, US

(73) Assignee: WARN INDUSTRIES, INC., Milwaukie, OR (US)

(21) Appl. No.: 12/207,183

(22) Filed: Sep. 9, 2008

(51) Int. Cl. H01H 5/00

(52) U.S. Cl. 200/402

(57) ABSTRACT

An electric contactor may include a first plunger member supporting a first contact member thereon, the first plunger member being movable between a disengaged position and an engaged position with respect to a first electrical terminal; a second plunger member supporting a second contact member thereon, the second plunger member being movable between a disengaged position and an engaged position with respect to a second electrical terminal; a first linear actuator selectively causing movement of the first plunger from the disengaged position to the engaged position; and a second linear actuator selectively causing movement of the second plunger from the disengaged position to the engaged position. Actuation of one of the first and second linear actuators will apply a weld breaking force against the plunger associated with the other of the first and second linear actuators.

### FIELD

The present disclosure relates to an electrical contactor and more particularly to a weld-breaking electrical contactor.

### BACKGROUND

This section provides background information related to the present disclosure which is not necessarily prior art.

A winch may be used to move a first object relative to a stationary second object by fixing the winch to one of the objects and engaging the winch's cable to the other object and subsequently winding the cable around a drum mechanism to pull the objects towards each other. Winches are commonly mounted to a vehicle and powered by the vehicle's battery or other power source. Winding and unwinding of a winch cable can be accomplished by switching the polarity of the DC current as applied to the winch motor. Vehicle-mounted winches often include remote control units enabling an operator to selectively wind, unwind and stop the rotation of the winch.

Such remote control units may include a contactor operable to selectively switch the polarity of the DC current and/or discontinue current flow to the motor by selectively engaging and/or disengaging one or more electrical contact members and one or more electrical terminals. High amperage current drawn through engaged contact members and terminals may generate sufficiently high heat to weld the contact member to the terminal, hindering disconnection of the contact member from the terminal.

### SUMMARY

This section provides a general summary of the disclosure, and is not a comprehensive disclosure of its full scope or all of its features.

An electric contactor may include a first plunger member supporting a first contact member thereon, the first plunger member being movable between a disengaged position and an engaged position with respect to a first electrical terminal; a second plunger member supporting a second contact member thereon, the second plunger member being movable between a disengaged position and an engaged position with respect to a second electrical terminal; a first linear actuator selectively causing movement of the first plunger from the disengaged position to the engaged position; and a second linear actuator selectively causing movement of the second plunger from the disengaged position to the engaged position. Actuation of one of the first and second linear actuators will apply a weld breaking force against the plunger associated with the other of the first and second linear actuators.

In another form, a contactor may include a first plunger member supporting a first contact member; a second plunger member supporting a second contact member; a first linear actuator adapted to selectively cause movement of the first contact member from a disengaged position to an engaged position relative to a first electrical terminal; a second linear actuator adapted to selectively cause movement of the second contact member from a disengaged position to an engaged position relative to a second electrical terminal; and a rocker selectively engaging the first and second plungers in response to actuation of either of the first and second linear actuators. If a weld develops between the first contact member and the first electrical terminal while the first contact member is in the engaged position, then actuation of the second linear actuator causing the second contact member to move towards the engaged position is operable to break the weld and force the first contact member toward the disengaged position.

In yet another form, a contactor may include a first plunger member supporting a first contact member thereon, the first plunger member being movable between a disengaged position and an engaged position with respect to a first electrical terminal; a second plunger member supporting a second contact member thereon, the second plunger member being movable between a disengaged position and an engaged position with respect to a second electrical terminal; a common armature engaging the first and second plungers, the first and second plungers extending axially therefrom; a first coil disposed around a first portion of the armature, and energizing the first coil causes the first contact member to move into the engaged position; and a second coil disposed around a second portion of the armature, and energizing the second coil causes the second contact member to move into the engaged position. If a weld develops between the first contact member and the first electrical terminal while the first contact member is in the engaged position, then actuation of the second linear actuator causing the second contact member to move towards the engaged position is operable to break the weld and force the first contact member toward the disengaged position.

In still another form, a contactor may include a first plunger member supporting a first contact member; a second plunger member supporting a second contact member, the second plunger being axially aligned with the first plunger member; a first linear actuator adapted to selectively cause movement of the first contact member from a disengaged position to an engaged position relative to a first electrical terminal; a second linear actuator adapted to selectively cause movement of the second contact member from a disengaged position to an engaged position relative to a second electrical terminal; and a spring disposed between the first and second contact members and biasing the first and second contact members away from each other. If a weld develops between the first contact member and the first electrical terminal while the first contact member is in the engaged position, then actuation of the second linear actuator causing the second contact member to move towards the engaged position is operable to break the weld and force the first contact member toward the disengaged position.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a vehicle-mounted winch having a remote control according to the principles of the present disclosure;

FIG. 2 is a cross-sectional view of a weld-breaking contactor in a static position according to the principles of the present disclosure;

FIG. 3 is a cross-sectional view of the weld-breaking contactor of FIG. 2 with a first contact member in an engaged position;

FIG. 4 is a cross-sectional view of the weld-breaking contactor of FIG. 2 with a second contact member in the engaged position;

FIG. 5 is a cross-sectional view of another embodiment of a weld-breaking contactor in a static position according to the principles of the present disclosure;

FIG. 6 is a cross-sectional view of the weld-breaking contactor of FIG. 5 having a first contact member in an engaged position;

FIG. 7 is a cross-sectional view of the weld-breaking contactor of FIG. 5 having a second contact member in the engaged position;

FIG. 8 is a cross-sectional view of yet another embodiment of a weld-breaking contactor in a static position according to the principles of the present disclosure;

FIG. 9 is a cross-sectional view of the weld-breaking contactor of FIG. 8 having a first contact member in an engaged position; and

FIG. 10 is a cross-sectional view of the weld-breaking contactor of FIG. 8 having a second contact member in the engaged position.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

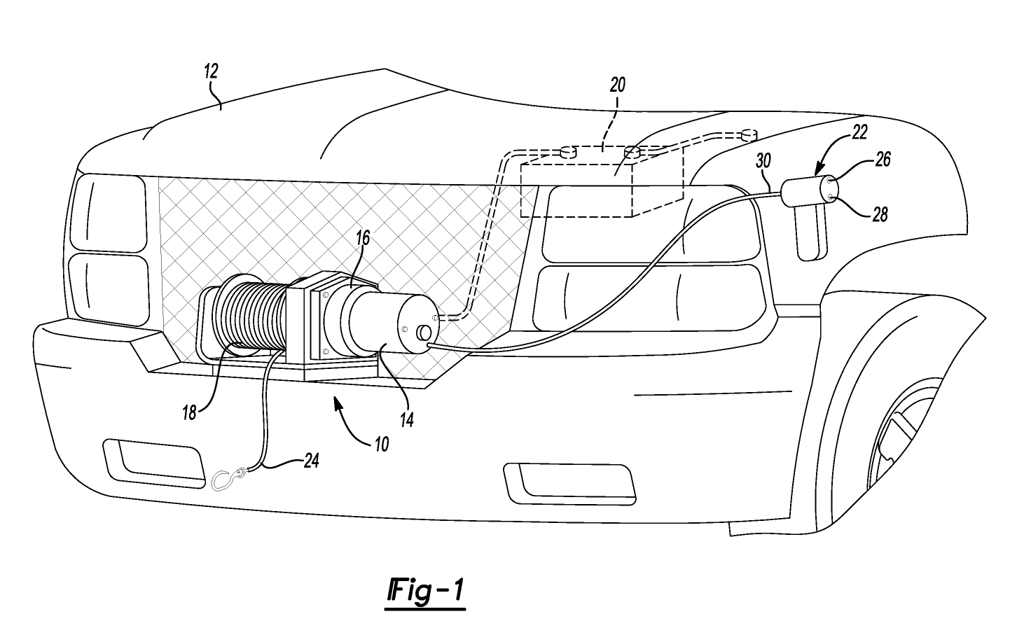

With reference to FIG. 1, a remote-controlled winch 10 is provided, which may be mounted to a vehicle 12, for example. The winch 10 includes an electric motor 14 which has an output shaft engaged with a switchable gear case 16 to provide driving torque to a drum mechanism 18. A battery 20, such as a 12 volt direct current vehicle battery, for example, or any other suitable power source, provides electric power to the electric motor 14. A remote control 22 may selectively cause rotation of the electric motor 14 in first and second directions, which in turn, causes rotation of the drum mechanism 18 in first and second directions to wind a cable 24 onto and off of the drum mechanism 18, respectively.

The remote control 22 may include a wind button 26, an unwind button 28 and a cord 30 interconnecting the remote control 22 and the electric motor 14 facilitating electrical communication therebetween. An operator may selectively actuate one of the wind button 26 and the unwind button 28 to control the rotational direction of the electric motor 14. The wind and unwind buttons 26, 28 can be of the type disclosed in Assignee's commonly owned U.S. Pat. No. 5,522,582, the disclosure of which is incorporated by reference herein in its entirety. It will be appreciated that a toggle switch (or the like) having wind, unwind and static state positions could be substituted for the wind and unwind buttons 26, 28. The buttons 26, 28 (or the toggle switch) are in electrical communication with a weld-breaking electric contactor 29 (FIG. 2), which is operable to selectively allow and prohibit high amperage electrical current flow in first and second directions, as will be subsequently described.

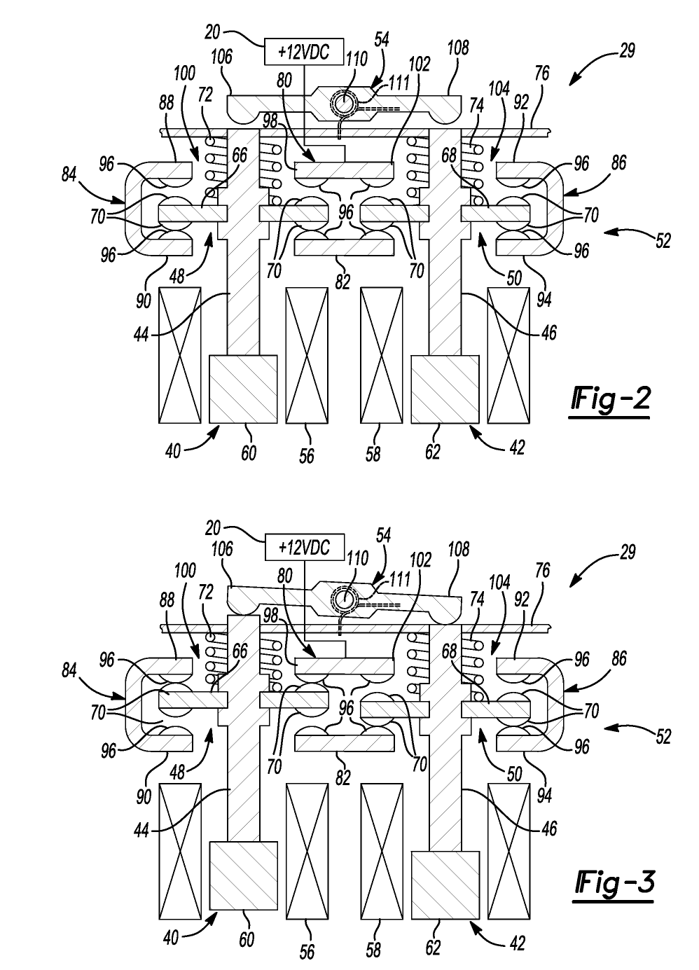

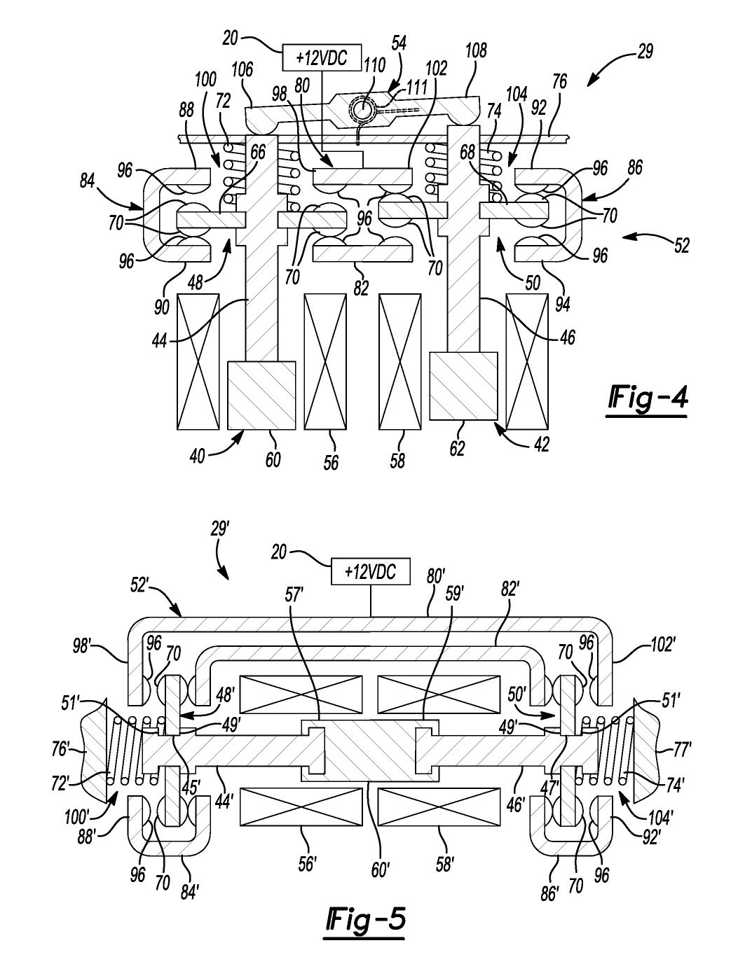

Referring now to FIGS. 2-4, the contactor 29 may include a wind solenoid 40, an unwind solenoid 42, a wind plunger 44, an unwind plunger 46, a wind contact member 48, an unwind contact member 50, a power circuit 52, and a rocker 54. The operator may manually actuate the wind button 26 which may energize the wind solenoid 40 to move the wind contact member 48 from a disengaged position (FIGS. 2 and 4) to an engaged position (FIG. 3) to allow electrical current to flow in a first direction to the motor 14 causing the drum mechanism 18 to wind the cable 24 thereon. To unwind the cable 24 from the drum mechanism 18, the operator may manually actuate the unwind button 28 which may energize the unwind solenoid 42 to move the unwind contact member 50 from a disengaged position (FIGS. 2 and 3) to an engaged position (FIG. 4) to allow electrical current to flow in a second direction to the motor 14.

The solenoids 40, 42 may include first and second coils 56, 58, respectively, and first and second armatures 60, 62, respectively. The coils 56, 58 may each include metallic wiring wound around a generally tubular core. The armatures 60, 62 may be generally cylindrical, magnetic members. Electrical current from the battery 20 (or any other source of electric power) may flow to one of the coils 56, 58 in response to the operator actuating the wind button 26 or unwind button 28, respectively. Current flowing through the first coil 56 or second coil 58 produces a magnetic field which forces the associated armature 60, 62, respectively, upward (relative to the view shown in FIG. 2). It should be appreciated that the solenoids 40, 42 could be substituted with any suitable linear actuator.

The plungers 44, 46 may be elongated, generally cylindrical members and may protrude from the armatures 60, 62, respectively, generally parallel to each other. The plungers 44, 46 may be engaged with the armatures 60, 62, respectively, or integrally formed therewith.

Contact members 48, 50 may be disposed on the plungers 44, 46, respectively, and may include bridge portions 66, 68 and a plurality of metallic protuberances 70. The bridge portions 66, 68 may extend from the plungers 44, 46, respectively, generally perpendicularly from the longitudinal axes thereof, forming generally cross-shaped cross sections. The protuberances 70 may be disposed on distal ends of the bridge portions 66, 68.

Spring members 72, 74 may be disposed around the plungers 46, 48, respectively. At a first end, the spring members 72, 74 may abut the contact members 48, 50, respectively, and at a second end, the spring members 72, 74 may abut a structural member 76. The structural member 76 may be fixed relative to a housing of the contactor 29 and could form a part of the housing. The plungers 44, 46 may be axially movable through apertures in the structural member 76. In this configuration, the spring members 72, 74 compress between the structural member 76 and the contact members 48, 50, respectively, as the associated plunger 44, 46 moves axially from the disengaged position to the engaged position. In this manner, the spring members 72, 74 bias the associated plungers 44, 46 and contact members 48, 50, respectively, toward the disengaged position.

The power circuit 52 may include a power member 80, an armature 82 of the motor 14, and first and second field coil leads 84, 86, respectively, of the motor 14. The power member 80 is in electrical communication with the battery 20. The first and second field coil leads 84, 86 may be in electrical communication with first and second poles of the motor 14. The first field coil lead 84 may have a generally U-shaped cross section including an upper portion 88 and a lower portion 90. The second field coil lead 86 may also have a generally U-shaped cross section including an upper portion 92 and a lower portion 94. Metallic protuberances 96 may be disposed on the power member 80, the armature 82 and the first and second field coil leads 84, 86.

The upper portion 88 of the first field coil lead 84 and a first portion 98 of the power member 80 form a wind terminal 100. The upper portion 92 of the second field coil lead 86 and a second portion 102 of the power member 80 form an unwind terminal 104. Engagement between the wind contact member 48 and the wind terminal 100 via protuberances 70, 96 (FIG. 3) allows electrical current to flow from the battery 20 to the motor 14 in a first direction, causing the drum mechanism 18 to turn in a first direction and wind the cable 24 thereon. Engagement between the unwind contact member 50 and the unwind terminal 104 via protuberances 70, 96 (FIG. 4) allows electrical current to flow from the battery 20 to the motor 14 in a second direction, causing the drum mechanism 18 to turn in a second direction and unwind the cable 24 therefrom.

The rocker 54 may include a first arm 106 and a second arm 108 disposed generally above distal ends of the plungers 44, 46 (relative to the views shown in FIGS. 2-4) and may be rotatably supported by a pin 110 disposed through a central portion of the rocker 54. Optionally, a centering spring 111 may bias the rocker 54 towards a generally horizontal position (relative to the view shown in FIG. 2). For example, the centering spring 111 could be a torsion spring disposed around the pin 110 and engaging the rocker 54 and any rotationally fixed structure (e.g., the structural member 76 or a structure supporting the pin 110) to bias the rocker 54 toward the generally horizontal position. It should be appreciated that the centering spring 111 could be any type of spring or combination of springs, including compression and tension coil springs and leaf springs, for example.

When both plungers 44, 46 are in the disengaged position (FIG. 2), there may be gaps between the first and second arms 106, 108 and the distal ends of the plungers 44, 46, respectively. These gaps allow sufficient clearance for one of the plungers 44 or 46 to move upward into the engaged position, while preventing the other of the plungers 44 or 46 from simultaneously moving into the engaged position.

With continued reference to FIGS. 2-4, operation of the contactor 29 will be described in detail. As described above, an operator may actuate one of the wind and unwind buttons 26, 28 to cause the motor 14 to rotate in first or second directions, respectively.

For example, actuating the wind button 26 allows electrical current to energize the wind solenoid 40, causing the wind plunger 44 to move upward into the engaged position (FIG. 3). Engagement between the contact member 48 and the wind terminal 100, via protuberances 70, 96, completes an electrical circuit to the motor 14, allowing high amperage current to flow from the battery 20, through the power plate 80, through the contact member 48, and into the first field coil 84, thereby causing the winch 10 to wind the cable 24 around the drum mechanism 18. The operator may cease operation of the winch 10 by releasing the wind button 26, de-energizing the solenoid 40, which may allow the spring 72 to bias the contact member 48 back into the disengaged position, prohibiting current flow to the motor 14.

The heat generated by the high amperage current flowing through the first terminal 100 and the wind contact member 48 can cause the protuberances 70, 96 of the contact member 48 and the terminal 100, respectively, to begin to melt and become welded together. The weld bonding the protuberances 70, 96 together may be sufficiently strong to retain the wind contact member 48 in the engaged position against the biasing force of the spring 72, even after the operator has released the wind button 26. In this manner, current may continue to flow through the first terminal 100 and the contact member 48 to the motor 14 even though the operator has released the wind button 26.

If such a welding event occurs, the operator may actuate the unwind button 28, energizing the unwind solenoid 42, thereby forcing the unwind plunger 46 upward toward the engaged position. The upward travel of the unwind plunger 46 forces the second arm 108 of the rocker 54 to rotate upward (relative to the view shown in FIG. 3) about the pin 110, thereby forcing the first arm 106 of the rocker 54 to rotate downward about the pin 110. This downward rotation of the first arm 106 transfers a sufficiently large downward force to the distal end of the wind plunger 44 to break the weld between the wind contact member 48 and the first terminal 100, subsequently returning the wind plunger 44 and the wind contact member 48 back to the disengaged position (FIG. 4). The operator may then release the unwind button 28 so that the spring 74 may force the unwind plunger 46 back into the disengaged position (FIG. 2), thereby prohibiting any current flow to the motor 14 and terminating rotation of the drum mechanism 18 in both directions.

It should be appreciated that if the operator holds down unwind button 28 to allow the unwind contact member 50 to reach the engaged position (FIG. 4), an electrical circuit will be completed allowing current to flow from the battery 20 through the power member 80, through the unwind contact member 50 and into the second field coil lead 86, causing the winch 10 to unwind the cable 24 from the drum mechanism 18. Releasing the unwind button 28 may allow the spring 74 to return the unwind contact member 50 to the disengaged position, however, heat from the high amperage current passing through the terminal 102 and the unwind contact member 50 can cause a weld to form therebetween in a similar manner as described above. If such a weld event occurs, the operator may actuate the wind button 26, causing the wind solenoid 40 to apply an upward force to the wind plunger 44. This force may then be transmitted through the rocker 54 to the unwind plunger 46, breaking the weld and forcing the unwind contact member 50 downward into the disengaged position, in a similar manner as described above.

With reference to FIGS. 5-8, another embodiment of the weld-breaking contactor is provided and is generally referred to as the contactor 29′. The contactor 29′ may include wind and unwind plungers 44′, 46′ arranged in a side-by-side configuration such that the plungers 44′, 46′ are coaxially aligned with each other. A common armature 60′ may engage both of the plungers 44′, 46′ such that the plungers 44′, 46′ are axially fixed relative to each other. Outer distal ends of the plungers 44′, 46′ may include grooves 45′, 47′, respectively. Each of the grooves 45′, 47′ may be defined by an inner shoulder 49′ and an outer shoulder 51′. Contact members 48′, 50′ may slidably engage the grooves 45′, 47′.

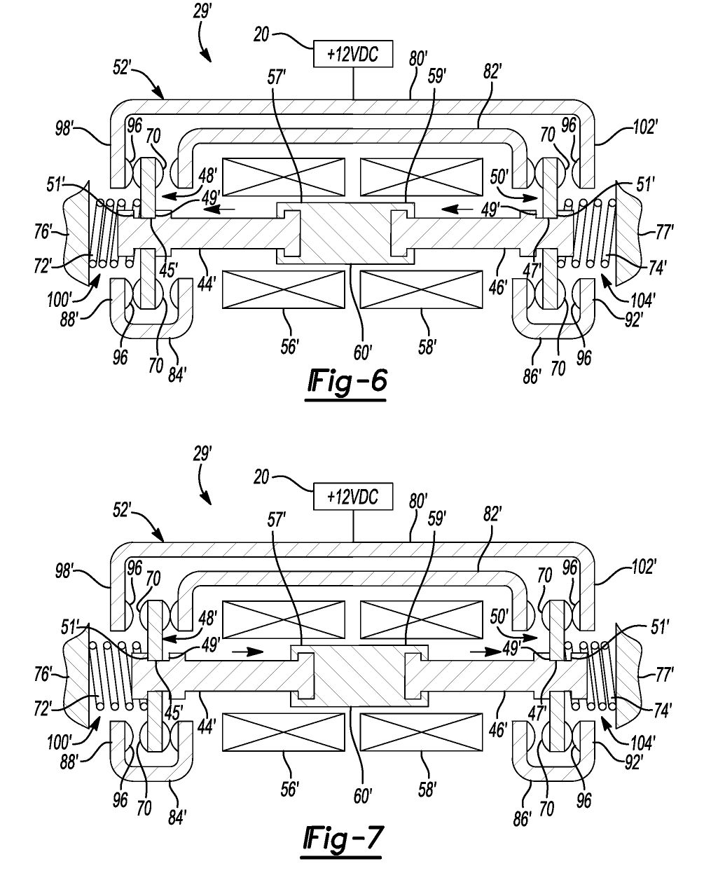

Wind and unwind coils 56′, 58′ may be disposed around first and second portions 57′, 59′ of the common armature 60′, respectively. Energizing the wind coil 56′ imparts a magnetic force on the first portion 57′ and the wind plunger 44′ causing axial movement of the armature 60′ and both plungers 44′ 46′ to the left (relative to the view shown in FIG. 5) into an engaged position (FIG. 6), whereby the wind contact member 48′ may contact a first terminal 100′ via protuberances 70, 96. The first terminal 100′ may include a first portion 98′ of a power member 80′ and an outer portion 88′ of a first field coil lead 84′ of the motor 14.

In a similar manner, energizing the unwind coil 56′ imparts a magnetic force on the second portion 59′ of the common armature 60′ and the unwind plunger 46′, causing axial movement of the common armature 60′ and both plungers 44′, 46′ to the right (relative to the view shown in FIG. 5) into an engaged position (FIG. 7), whereby the unwind contact member 50′ may contact a second terminal 104′ via protuberances 70, 96. The second terminal 104′ may include a second portion 102′ of the power member 80′ and an outer portion 92′ of a second field coil lead 86′ of the motor 14.

A first spring member 72′ may be disposed around at least a portion of the wind plunger 44′, between a first fixed structural member 76′ and the wind contact member 48′, thereby biasing the wind contact member 48′ toward a disengaged position (FIGS. 5 and 7). In a similar manner, a second spring member 74′ may be disposed around at least a portion of the unwind plunger 46′, between a second fixed structural member 77′ and the unwind contact member 50′, thereby biasing the unwind contact member 50′ toward a disengaged position (FIGS. 5 and 6). The grooves 45′, 47′ may have a sufficiently large width relative to a thickness of the contact members 48′, 50′ to allow one of the plungers 44′, 46′ and the corresponding contact member 48′ or 50′ to move into the engaged position, while the other of the contact members 48′ or 50′ can remain in the disengaged position. The width of the grooves 45′, 47′ is also sufficiently narrow relative to the thickness of the contact members 48′, 50′ to prevent both of the contact members 48′, 50′ from simultaneously engaging the corresponding terminal 100′ or 104′.

With continued reference to FIGS. 5-7, operation of the contactor 29′ will be described in detail. An operator can actuate the wind button 26 to energize the wind coil 56′, thereby magnetically forcing the wind plunger 44′ to the left (relative to the view shown FIG. 5). In this manner, the inner shoulder 49′ of the wind plunger 44′ may force the wind contact member 48′ into the engaged position (FIG. 6). This engagement between the wind contact member 48′ and the first terminal 100′ may complete an electrical circuit allowing electrical high amperage current to flow from the battery 20, through the power member 80′, through the wind contact member 48′ and into the first field coil lead 84′, causing the motor 14 to wind the cable 24 onto the drum mechanism 18. Since both of the plungers 44′, 46′ may be axially fixed relative to each other, energizing the wind coil 56′ may cause both of the plungers 44′, 46′ and the common armature 60′ to move to the left (FIGS. 5 and 6) together as a unitary member.

In a similar manner, actuation of the unwind button 28 energizes the unwind coil 58′, electromagnetically forcing the common armature 60′ and the unwind plunger 46′ (and hence the wind plunger 44′) to move to the right (relative to the view shown in FIG. 5). The inner shoulder 49′ of the unwind plunger 46′ forces the unwind contact member 50′ into the engaged position (FIG. 7). This engagement between the unwind contact member 50′ and the second terminal 104′ may complete an electrical circuit, allowing high amperage current to flow from the battery 20, through the power member 80′, through the unwind contact member 50′ and into the second field coil lead 86′, causing the motor 14 to unwind the cable 24 from the drum mechanism 18.

As described above, when one of the contact members 48′, 50′ are in the engaged position, heat generated by the high amperage current can weld the contact members 48′ or 50′ to its associated electrical terminal 100′, 104′, respectively, which may retain the contact member 48′ or 50′ in the engaged position despite the biasing force of the corresponding spring member 72′, 74′. If such a weld event occurs between the wind contact member 48′ and the first terminal 100′, for example, the operator may actuate the unwind button 28, thereby energizing the unwind coil 58′. The resultant electromagnetic force moves the plungers 44′, 46′ and common armature 60′ to the right (relative to the view shown in FIG. 6) causing the outer shoulder 51′ of the wind plunger 44′ to bias the wind contact member 48′ toward the disengaged position with sufficient force to break the weld between the wind contact member 48′ and the first terminal 100′. The operator may then release the unwind button 28 to allow the spring member 74′ to bias the unwind contact member 50′ back to the disengaged position, such that both of the contact members 48′, 50′ may be in the disengaged position (FIG. 5).

If a weld event occurs between the unwind contact member 50′ and the second terminal 104′, the weld may be broken in a similar manner as described above. The operator may actuate the wind button 26, energizing the wind coil 58′, thereby electromagnetically forcing the plungers 44′, 46′ and the common armature 60′ to the left (relative to the view shown in FIG. 7). The outer shoulder 51′ of the unwind plunger 46′ biases the unwind contact member 50′ away from the second terminal 104′ with sufficient force to break the weld therebetween and return the unwind contact member 50′ to the disengaged position. Subsequently releasing the wind button 26 may allow the spring member 72′ to force the wind contact member 48′ back into the disengaged position (FIG. 5), thereby preventing current flow to the motor 14.

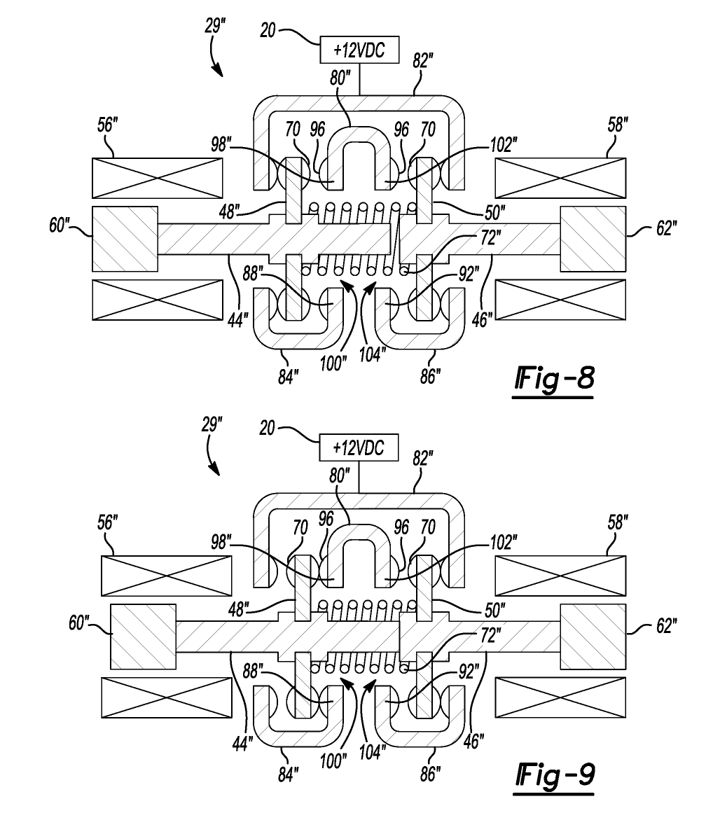

Referring now to FIGS. 8-10, yet another embodiment of a contactor is provided and is generally referred to as the contactor 29″. The contactor 29″ may include wind and unwind plungers 44″, 46″, wind and unwind contact members 48″, 50″, wind and unwind coils 56″, 58″ and first and second electrical terminals 100″, 104″ disposed between the contact members 48″, 50″. The first terminal 100″ may include a first portion 98″ of a power member 80″ and an inner portion 88″ of a first field coil lead 84″ of the motor 14. The second terminal 104″ may include a second portion 102″ of the power member 80″ and an inner portion 92″ of a second field coil lead 86″.

The plungers 44″, 46″ may extend inwardly from wind and unwind armatures 60″, 62″, respectively, and may be generally coaxially aligned and axially movable relative to each other. The contact members 48″, 50″ may be fixedly engaged with the plungers 44″, 46″, respectively. A spring member 72″ may be disposed around one or both of the plungers 44″, 46″, abutting the contact members 48″, 50″. Movement of one of the plungers 44″, 46″ toward the other of the plungers 44″, 46″ compresses the spring member 72″ between the contact members 48″, 50″, which biases the plungers 44″, 46″ away from each other toward disengaged positions (FIG. 8).

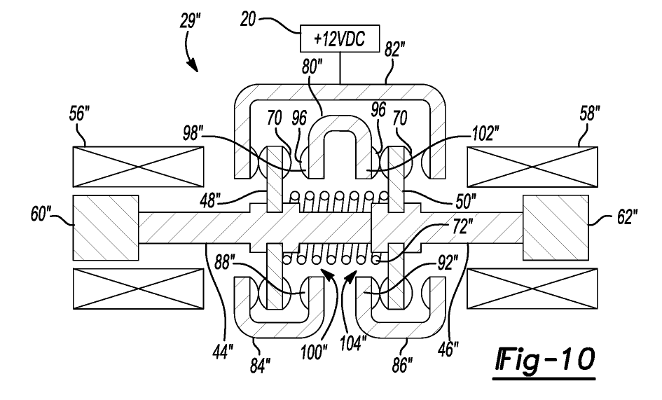

When both contact members 48″, 50″ are in a disengaged position (FIG. 8), inwardly disposed ends of the plungers 44″, 46″ may be spaced apart from each other, forming a gap therebetween. The gap is sized to allow clearance for only one of the plungers 44″, 46″ to move the corresponding contact member 48″, 50″, respectively, into an engaged position (FIGS. 9 and 10, respectively).

Engagement between the wind contact member 48″ and the first terminal 100″ via protuberances 70, 96, completes an electrical circuit allowing high amperage current to flow from the battery 20, through the power member 80″, through the wind contact member 48″ and into the first field coil lead 84″, thereby causing the motor 14 to rotate in a first direction. Similarly, engagement between the unwind contact member 50″ and the second terminal 104″, via protuberances 70, 96, completes an electrical circuit allowing high amperage current to flow from the battery 20, through the power member 80″, through the unwind contact member 50″ and into the second field coil lead 86″, thereby causing the motor 14 to rotate in a second direction.

With continued reference to FIGS. 8-10, operation of the contactor 29″ will be described in detail. In a similar manner as described above, actuation of the wind button 26 energizes the wind coil 56″, which causes the wind plunger 44″ to move to the right (relative to the view shown in FIG. 8), engaging the wind contact member 48″ with the first terminal 100″, allowing current flow to the motor 14 in the first direction. To halt the current flow, the operator may release the wind button 26 to allow the spring member 72″ to bias the wind contact member 48″ back to the disengaged position.

If the wind contact member 48″ and the first terminal 100″ become welded together in the manner described above, the operator may actuate the unwind button 28 to break the weld. Actuating the unwind button 28 energizes the unwind coil 58″, which forces the unwind plunger 46″ to the left (relative to the view shown in FIG. 9), thereby biasing the wind plunger 44″ and wind contact member 48″ away from the first terminal 100″ with sufficient force to break the weld therebetween. The operator may then release the unwind button 28 to allow the spring member 72″ to bias the unwind contact member 50″ back into the disengaged position (FIG. 8).

If the unwind contact member 50″ and the second terminal 104″ become welded together in the manner described above, the operator may actuate the wind button 26 to break the weld. Actuating the wind button 26 energizes the wind coil 56″, which forces the wind plunger 44″ to the right (relative to the view shown in FIG. 10), thereby biasing the unwind plunger 46″ and unwind contact member 50″ away from the second terminal 104″ with sufficient force to break the weld therebetween. The operator may then release the wind button 26 to allow the spring member 72″ to bias the wind contact member 48″ back into the disengaged position.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. An electric contactor, comprising:
a first plunger member supporting a first contact member thereon, said first plunger member being movable between a disengaged position and an engaged position with respect to a first electrical terminal;
a second plunger member supporting a second contact member thereon, said second plunger member being movable between a disengaged position and an engaged position with respect to a second electrical terminal;
a first linear actuator associated with said first plunger for causing movement of said first plunger from said disengaged position to said engaged position upon actuation of said first linear actuator; and
a second linear actuator associated with said second plunger for causing movement of said second plunger from said disengaged position to said engaged position upon actuation of said second linear actuator,
wherein actuation of one of said first and second linear actuators will apply a weld breaking force against said plunger associated with the other of said first and second linear actuators.

2. The electric contactor according to claim 1, wherein said first and second plunger members are coaxially aligned.

3. The electric contactor according to claim 2, further comprising a spring member for biasing said first and second plunger members away from one another.

4. The electric contactor according to claim 2, further comprising means for biasing said first and second plunger members away from said engaged position.

5. The electric contactor according to claim 2, further comprising a first spring for biasing said first plunger member away from said engaged position and a second spring for biasing said second plunger member away from said engaged position.

6. The electric contactor according to claim 1, further comprising a rocker member adapted to be engaged by said first and second plunger members and for preventing said first and second contact members from simultaneously engaging said first and second electrical terminals.

7. The electric contactor according to claim 6, further comprising a centering spring biasing said rocker toward a level position perpendicular to said plungers.

8. The electric contactor according to claim 6, wherein said first and second plunger members are axially moveable along generally parallel axes.

9. The electric contactor according to claim 6, further comprising a first spring for biasing said first plunger member toward said disengaged position and a second spring for biasing said second plunger member toward said disengaged position.

10. The electric contactor according to claim 6, wherein a gap is provided between at least one of said first and second plunger members and said rocker member when said first and second plunger members are both in said disengaged position.

11. The electric contactor according to claim 6, wherein said rocker member is engaged by end portions of said first and second plunger members when said first and second electric solenoids are activated, respectively.

12. The electric contactor according to claim 1, wherein said first and second plunger members are generally coaxially aligned and are provided with a gap therebetween when said first and second plunger members are both in said disengaged position.

13. The electric contactor according to claim 12, wherein:
when said first linear actuator is activated, said first plunger member moves toward said second plunger member; and
when said second linear actuator is activated, said second plunger member moves toward said first plunger member.

14. The electric contactor according to claim 1, wherein said first and second plunger members are attached to each other, and said first contact member is axially movable relative to said first plunger member and said second contact member is axially movable relative to said second plunger member.

15. The electric contactor according to claim 14, further comprising a first spring biasing said first contact member away from said first electrical terminal and a second spring biasing said second contact member away from said second electrical terminal.

16. The electric contactor according to claim 14, further comprising means for biasing said first and second contact members away from said first and second electrical terminals, respectively.

17. The electric contactor according to claim 1, wherein said first and second linear actuators are electric solenoids.

18. The electric contactor according to claim 1, wherein engagement between one of said first and second contact members and said first and second electrical terminals, respectively, allows electrical current to flow in a first direction, thereby causing a winch to unwind a cable from a drum mechanism; and further wherein engagement between the other of said first and second contact members and said first and second electrical terminals, respectively, allows electrical current to flow in a second direction, thereby causing said winch to wind said cable around said drum mechanism.

19. A weld breaking contactor comprising:
a first plunger member supporting a first contact member;
a second plunger member supporting a second contact member;
a first linear actuator adapted to selectively cause movement of said first contact member from a disengaged position to an engaged position relative to a first electrical terminal;
a second linear actuator adapted to selectively cause movement of said second contact member from a disengaged position to an engaged position relative to a second electrical terminal; and
a rocker selectively engaging said first and second plungers in response to actuation of either of said first and second linear actuators,
wherein if a weld develops between said first contact member and said first electrical terminal while said first contact member is in said engaged position, then actuation of said second linear actuator causing said second contact member to move towards said engaged position is operable to break said weld and force said first contact member toward said disengaged position.

20. The weld-breaking contactor according to claim 19, wherein if a weld develops between said second contact member and said second electrical terminal while said second contact member is in said engaged position, then actuation of said first linear actuator causing said first contact member to move towards said engaged position is operable to break said weld and force said second contact member toward said disengaged position.

21. The weld-breaking contactor according to claim 19, wherein said rocker prevents said first and second contact members from simultaneously engaging said first and second electrical terminals, respectively.

22. The weld-breaking contactor according to claim 19, further comprising a first spring biasing said first contact member away from said engaged position, and a second spring biasing said second contact member away from said engaged position.

23. The weld-breaking contactor according to claim 19, wherein said first and second plunger members are axially moveable along generally parallel axes.

24. The weld-breaking contactor according to claim 19, wherein said first and second linear actuators are electric solenoids.

25. The weld-breaking contactor according to claim 19, wherein a gap is provided between at least one of said first and second plunger members and said rocker when said first and second plunger members are both in said disengaged position.

26. The weld-breaking contactor according to claim 19, wherein said first contact member is fixedly engaged with said first plunger member, and said second contact member is fixedly engaged with said second plunger.

27. The weld-breaking contactor according to claim 19, wherein a centering spring biases said rocker towards a level position substantially perpendicular to said plungers.

28. The weld-breaking contactor according to claim 19, wherein engagement between one of said first and second contact members and said first and second electrical terminals, respectively, allows electrical current to flow in a first direction, thereby causing a winch to unwind a cable from a drum mechanism; and further wherein engagement between the other of said first and second contact members and said first and second electrical terminals, respectively, allows electrical current to flow in a second direction, thereby causing said winch to wind said cable around said drum mechanism.

29. A weld-breaking contactor comprising:
a first plunger member supporting a first contact member thereon, said first plunger member being movable between a disengaged position and an engaged position with respect to a first electrical terminal;
a second plunger member supporting a second contact member thereon, said second plunger member being movable between a disengaged position and an engaged position with respect to a second electrical terminal;
a common armature engaging said first and second plungers, said first and second plungers extending axially therefrom;
a first coil disposed around a first portion of said armature, and energizing said first coil causes said first contact member to move into said engaged position; and
a second coil disposed around a second portion of said armature, and energizing said second coil causes said second contact member to move into said engaged position,
wherein if a weld develops between said first contact member and said first electrical terminal while said first contact member is in said engaged position, then actuation of said second linear actuator causing said second contact member to move towards said engaged position is operable to break said weld and force said first contact member toward said disengaged position.

30. The weld-breaking contactor according to claim 29, wherein if a weld develops between said second contact member and said second electrical terminal while said second contact member is in said engaged position, then actuation of said first linear actuator causing said first contact member to move towards said engaged position is operable to break said weld and force said second contact member toward said disengaged position.

31. The weld-breaking contactor according to claim 29, further comprising a first spring biasing said first contact member away from said engaged position, and a second spring biasing said second contact member away from said engaged position.

32. The weld-breaking contactor according to claim 29, wherein said first and second plunger members are generally coaxially aligned.

33. The weld-breaking contactor according to claim 29, wherein said first contact member is axially movable relative to said first plunger member, and said second contact member is axially movable relative to said second plunger member.

34. The weld-breaking contactor according to claim 29, wherein said first and second plunger members are axially fixed relative to each other.

35. The weld-breaking contactor according to claim 29, wherein engagement between one of said first and second contact members and said first and second electrical terminals, respectively, allows electrical current to flow in a first direction, thereby causing a winch to unwind a cable from a drum mechanism; and further wherein engagement between the other of said first and second contact members and said first and second electrical terminals, respectively, allows electrical current to flow in a second direction, thereby causing said winch to wind said cable around said drum mechanism.

36. A weld-breaking contactor comprising:
a first plunger member supporting a first contact member;
a second plunger member supporting a second contact member, said second plunger being axially aligned with said first plunger member;
a first linear actuator adapted to selectively cause movement of said first contact member from a disengaged position to an engaged position relative to a first electrical terminal;
a second linear actuator adapted to selectively cause movement of said second contact member from a disengaged position to an engaged position relative to a second electrical terminal; and
a spring disposed between said first and second contact members and biasing said first and second contact members away from each other,
wherein if a weld develops between said first contact member and said first electrical terminal while said first contact member is in said engaged position, then actuation of said second linear actuator causing said second contact member to move towards said engaged position is operable to break said weld and force said first contact member toward said disengaged position.

37. The weld-breaking contactor according to claim 36, wherein if a weld develops between said second contact member and said second electrical terminal while said second contact member is in said engaged position, then actuation of said first linear actuator causing said first contact member to move towards said engaged position is operable to break said weld and force said second contact member toward said disengaged position.

38. The weld-breaking contactor according to claim 36, wherein said first and second plunger members are generally coaxially aligned and are provided with a gap therebetween when said first and second plunger members are both in said disengaged position.

39. The weld-breaking contactor according to claim 36, wherein:
when said first linear actuator is activated, said first plunger member moves toward said second plunger member; and
when said second linear actuator is activated, said second plunger member moves toward said first plunger member.

40. The weld-breaking contactor according to claim 36, wherein engagement between one of said first and second contact members and said first and second electrical terminals, respectively, allows electrical current to flow in a first direction, thereby causing a winch to unwind a cable from a drum mechanism; and further wherein engagement between the other of said first and second contact members and said first and second electrical terminals, respectively, allows electrical current to flow in a second direction, thereby causing said winch to wind said cable around said drum mechanism.
